(19) United States
(12) Patent Application Publication
(10) Pub. No.: US 2004/0062980 A1
(43) Pub. Date: Apr. 1, 2004

(54) Fluid management component for use in a fuel cell

(76) Inventors: Xiaoming Ren, Guilderland, NY (US); Shimshon Gottesfeld, Niskayuna, NY (US); Juan J. Becerra, Altamont, NY (US); Robert S. Hirsch, Troy, NY (US)

Correspondence Address: CESARI AND MCKENNA, LLP, 88 BLACK FALCON AVENUE, BOSTON, MA, 02210, US

(21) Appl. No.: 10/260,820

(22) Filed: Sep. 30, 2002

(51) Int. Cl. H01M 8/02

(52) U.S. Cl. 429/39; 429/34

(57) ABSTRACT

A passive fluid management component for a direct oxidation fuel cell is provided. It enables the introduction of highly concentrated methanol solutions, including neat methanol, directly into the anode, eliminating the need of mechanical modes of dosing and/or mixing a methanol/water solution to control the local concentration at the anode. The fluid management of the present invention can be based on pores formed in the component of a specific size and spacing to allow anode reactants to flow through the component towards the anode face of the membrane electrolyte of the fuel cell at a controlled rate. The pore size can be adjusted to allow the highest concentrations possible of methanol, including neat methanol, to be introduced in direct contact with the outer face of the component, said component being capable of lowering, under current, the local concentration of methanol at the anode face of the membrane electrolyte to the level required to minimize methanol loss. The pore walls can be made to be hydrophilic to facilitate the flow of water or methanol based fluids. The component of the present invention may also include channels formed therein which will direct the flow of carbon dioxide away from the anode of the fuel cell and to a venting or collection site. The fluid management component of the present invention can also be used to replace the conventional anode diffusion layer in an embodiment in which the component is of a conductive material. It is used in addition to an anode diffusion layer in an embodiment in which the component could be a non-conductive material, or where better surface contact to the anode face of the membrane is enabled by a conventional diffusion layer.

### BACKGROUND OF THE INVENTION

1. Field of the Invention

This invention relates generally to direct oxidation fuel cells, and more particularly, to components for managing fluids within such fuel cells.

2. Background Information

Fuel cells are devices in which electrochemical reactions are used to generate electricity. A variety of materials may be suited for use as a fuel depending upon nature of the fuel cell. Organic materials, such as methanol or natural gas, are attractive fuel choices due to the their high specific energy.

Fuel cell systems may be divided into “reformer-based” systems (i.e., those in which the fuel is processed in some fashion to extract hydrogen from the fuel before it is introduced into the fuel cell) or “direct oxidation” systems in which the fuel is fed directly into the cell without the need for separate internal or external processing. Most currently available fuel cells are reformer-based fuel cell systems. However, because fuel processing is complex, and requires expensive components, which occupy comparatively significant volume, reformer based systems are presently limited to comparatively large, high power applications.

Direct oxidation fuel cell systems may be better suited for a number of applications in smaller mobile devices (e.g., mobile phones, handheld and laptop computers), as well as in some larger scale applications. In direct oxidation fuel cells of interest here, a carbonaceous liquid fuel in an aqueous solution (typically aqueous methanol) is applied to the anode face of a membrane electrode assembly (MEA). The MEA contains a protonically conductive, but electronically non-conductive membrane (PCM). Typically, a catalyst, which enables direct oxidation of the fuel on the anode aspect of the PCM, is disposed on the surface of the PCM (or is otherwise present in the anode chamber of the fuel cell). In the fuel oxidation process at the anode, the products are protons, electrons and carbon dioxide. Protons (from hydrogen in the fuel and water molecules involved in the anodic reaction) are separated from the electrons. The protons migrate through the PCM, which is impermeable to the electrons. The electrons travel through an external circuit, which includes the load, and are united with the protons and oxygen molecules in the cathodic reaction, thus providing electrical power from the fuel cell.

One example of a direct oxidation fuel cell system is a direct methanol fuel cell system or DMFC system. In a DMFC system, a mixture comprised predominantly of methanol and water is used as fuel (the “fuel mixture”), and oxygen, preferably from ambient air, is used as the oxidizing agent. The fundamental reactions are the anodic oxidation of the methanol and water in the fuel mixture into CO₂, protons, and electrons; and the cathodic combination of protons, electrons and oxygen into water. The overall reaction may be limited by the failure of either of these reactions to proceed at an acceptable rate (more specifically, slow oxidation of the fuel mixture will limit the cathodic generation of water, and vice versa).

Direct methanol fuel cells are being developed towards commercial production for use in portable electronic devices. Thus, the DMFC system, including the fuel cell and the other components should be fabricated using materials and processes that not only optimize the electricity-generating reactions, but which are also cost effective. Furthermore, the manufacturing process associated with a given system should not be prohibitive in terms of associated labor or manufacturing cost or difficulty.

Typical DMFC systems include a fuel source, fluid and effluent management and air management systems, and a direct methanol fuel cell (“fuel cell”). The fuel cell typically consists of a housing, hardware for current collection and fuel and air distribution, and a membrane electrode assembly (“MEA”) disposed within the housing.

A typical MEA includes a centrally disposed, protonically conductive, electronically non-conductive membrane (“PCM”). One example of a commercially available PCM is Nafion® a registered trademark of E. I. Dupont de Nemours and Company, a cation exchange membrane comprised of polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the anode face of the PCM, while allowing the gaseous product of the reaction, typically carbon dioxide, to move away from the anode face of the PCM. In the case of the cathode side, a diffusion layer is used to achieve a fast supply and even distribution of gaseous oxygen across the cathode face of the PCM, while minimizing or eliminating the collection of liquid, typically water, on the cathode aspect of the PCM. Each of the anode and cathode diffusion layers also assist in the collection and conduction of electric current from the catalyzed PCM.

The diffusion layers are conventionally fabricated of carbon paper or a carbon cloth, typically with a thin, porous coating made of a mixture of carbon powder and Teflon. Such carbon paper or carbon cloth components allow a relatively high flux of methanol when immersed in a liquid methanol and water fuel mixture. While some methanol access through the anode diffusion layer is required for maintaining anode, and therefore cell current, a high flux of methanol through the anode diffusion layer is a shortcoming because most presently available membrane electrolytes suitable for use in a DFMC system are typically permeable to methanol and concentrated fuel which, if introduced into the anode chamber, can thus pass at a significant rate through the diffusion layer and the membrane and oxidize on the cathode face of the membrane. This results in wasted fuel as well as diminished cathode performance, leading to diminished performance of the fuel cell and fuel cell system.

Solutions to this shortcoming include the design of DMFC systems which carry a dilute methanol solution in the fuel tank or cartridge, but this can substantially increase the overall volume of the system to achieve some required energy content. Alternatively, fuel flow control systems can be used to manage the concentration of fuel in the fuel/water mixture within the anode electrode (anode) at relatively low levels by controlled introduction of concentrated or dilute fuel, as required depending on the circumstances. However such fuel management devices add undesirable volume, complexity and cost to the system.

Traditional DMFC structures have required that the diffusion layers perform a current conduction function as well as managing the introduction and removal of reactants and products within the MEA. Thus, these layers have had to be electrically conductive, as well as capable of managing the transport of liquids and gasses within the MEA. As noted, conventionally the diffusion layers have been fabricated of carbon paper and carbon cloth, and are implemented in order to encourage the transport of reactants to the catalyst coated PCM, as well as the transport of products away from the catalyst coated PCM.

U.S. Pat. No. 6,296,964, Enhanced Methanol Utilization in Direct Methanol Fuel Cell, by Ren et al. (Ren) describes another function of the anode diffusion layer in a DMFC. Specifically, a concentration drop across the anode diffusion layer occurs when the cell is under current. This concentration drop allows the DMFC system to operate with less methanol crossover with anode feed methanol concentrations of approximately 1 molar methanol. The Ren patent describes the use of a single ordinary carbon cloth diffusion layer approximately 0.25 mm thick, to lower the concentration of methanol at the anode surface of the membrane electrolyte by as much as 80-90 percent as compared to the methanol concentration on the aspect of the diffusion layer opposite the membrane electrolyte when the methanol concentration of the fuel mixture being introduced to the anode diffusion layer is 1 molar, or less.

Use of backing layers has resulted in the need to limit the methanol concentration to which the anode diffusion layer is exposed at, or below, approximately 1 M. However, it is highly preferable to implement a simpler system that will not require methanol dilution or mixing subsystems. This will also minimize the expense of the system, and increase its reliability. Diffusion layers used in fuel cells are comprised of porous carbon paper or carbon cloth, typically between 100-500 microns thick. 4-12 sheets of carbon paper will have to be “stacked” to generate an anode diffusion layer that would create a much larger methanol concentration drop under cell current, thus enabling the introduction of a fuel solution into the anode that is substantially greater than 10% methanol. This will make the overall cell thickness excessive. Also, each of these sheets of carbon paper is typically “wet-proofed” with Teflon or otherwise treated in a manner that makes the diffusion layer hydrophobic to prevent liquid water from saturating the diffusion layer. Such “wet-proofing” may not be ideal for the anode of a DMFC or other direct oxidation fuel cell system.

A metallic diffusion layer or a metallic diffusion layer combined with a flow field plate in a direct oxidation fuel cell has been described for use as a controlled methanol transport barrier. The metallic layer component can be manufactured using particle diffusion bonding techniques as described in commonly owned U.S. patent application Ser. No. 09/882,699 which was filed on Jun. 15, 2001, for a Metallic Layer Component For Use In a Direct Oxidation Fuel Cell.

Those skilled in the art will recognize that materials other than metals may offer advantages for certain architectures or designs. For example, many polymers are less expensive, and easier to mold or form into a desired structure than metals, provided that there are alternate structures and methods in place to collect current and provide other desired characteristics. In addition, the use of polymers allows for precise engineering of the size and shape of the pores in the component, and may be further desirable as it is possible to utilize a chemically inert polymer.

Another fluid, which should be managed at the DMFC anode, is carbon dioxide. As noted, the anodic reaction of the DMFC produces carbon dioxide as a product. It is preferred to separate and remove the carbon dioxide product from the methanol fuel mixture in the anode. Carbon dioxide may be treated as a waste and be removed from the system or can be used to perform mechanical work within the DMFC system before it is vented or otherwise removed. Thus, carbon dioxide must also be managed by the introduction of a fluid management component at the anode aspect of the fuel cell.

As such, there remains a need for a fluid management component for use in a fuel cell which enables a uniform presentation of a fuel mixture of sufficiently low concentration to the anode diffusion layer while allowing the highest possible concentration of fuel to be carried directly into the anode compartment. Further advantages of such an element would include the collection of electrons generated by the anodic reaction and the direction of carbon dioxide to a predetermined venting site.

It is an object of the present invention to provide a fluid management component for use in a fuel cell anode which enhances system performance by providing effective fluid management within the fuel cell, which does not increase the overall system volume, and which has the potential to reduce the complexity and cost of the system.

### SUMMARY OF THE INVENTION

The deficiencies of presently available diffusion layers are overcome by the solutions provided by the present invention which is a fuel cell component that is disposed within the anode chamber to manage the flow and distribution of a liquid fuel mixture to the catalyzed membrane of the fuel cell. The fuel cell component may be used with a conventional diffusion layer or as a replacement for the conventional diffusion layer of a fuel cell. It is a passive fluid management component that enables the introduction of highly concentrated methanol solutions, including neat methanol, directly into the anode, eliminating the need of mechanical modes of dosing and/or mixing a methanol/water solution to control the local concentration at the anode. The component is typically a plate comprised of a material that does not react with the substances in the cell, and which does not adversely affect the performance of the fuel cell system. The component may be fabricated from a variety of materials, including but not limited to: silicon and silicon derivatives such as silicon dioxide; carbon and graphite; ceramics; non-reactive metals; and treated fiberglass.

In a first embodiment of the invention, where the fluid flow through the element is determined by diffusion, rather than hydraulic permeability, the plate is perforated with a multitude of pores or openings of other geometric shapes, at substantially regular intervals across the component. The diameter of the pores and the distance between the pores are engineered: 1) to maintain a relatively uniform distribution of fuel across the area of the diffusion layer and/or the catalyzed anode surface of the PCM, and 2) to maintain a stable, predetermined concentration gradient and therefore, stable flow across the component. The pore size and spacing, and the component thickness thus allow for a relatively uniform distribution of the fuel mixture across the area of the diffusion layer and/or the area of the catalyzed membrane while maintaining a steep concentration gradient across the component, thus decreasing the methanol concentration in the fuel mixture that is introduced to the catalyst-coated anode aspect of the membrane electrolyte, to a concentration that is well below the high concentration methanol fed into the fuel cell anode.

In accordance with one aspect of the invention, the pore walls are hydrophilic in nature to encourage the flow of liquid aqueous methanol fuel solution to the anode side of the catalyzed membrane electrolyte, and to discourage the back flow of anodically generated gasses through the component. In addition, one or both of the aspects of the plate may be hydrophilic in nature to encourage the more even lateral distribution of the fuel to the catalyzed membrane electrolyte. More specifically, the surfaces of the plate may be treated with a material or subjected to a deposition film growth process (such as oxidation) that renders the surfaces of the fluid conducting areas substantially hydrophilic. In addition, certain areas of the component that are to repel liquid and transport gaseous species may be rendered hydrophobic by material deposition or surface treatments, such as polymer surface fluorination or coating the component with PTFE, to establish the desired hydrophobic qualities.

Alternatively, in another aspect of this embodiment, the pores of the element may be filled with a material that is permeable to the flow of the liquid fuel mixture, but not product gasses, in order to discourage the removal of any gasses present by back-flow through the porous plate.

In accordance with another aspect of the invention, the fuel cell component can also be used to control the exit flow of product gases, such as carbon dioxide. In this embodiment of the invention, the component is etched or machined with channels on one face, which is adjacent to the membrane electrolyte, or adjacent to the aspect of the diffusion layer opposite the membrane electrolyte. The channels allow anodically generated carbon dioxide to be collected and directed to a predetermined collection point or vented out to the ambient environment.

The component of the present invention can be used in a fuel cell which includes a diffusion layer, or may be used as a replacement for a conventional anode diffusion layer provided that the component is fabricated in such a manner that it is highly electrically conductive, or a current collector element is added to replace this function of the diffusion layer. In an application in which the component does not act as the current collector, it may be fabricated from an insulative material.

### BRIEF DESCRIPTION OF THE DRAWINGS

The invention will be described with reference to the accompanying drawings, in which:

FIG. 1 is a schematic block diagram of a direct oxidation fuel cell system with which the fluid management component of the present invention may be employed;

FIG. 2 is an isometric illustration of one example of the fluid management component of the present invention showing several pores in a cut-away schematic;

FIG. 3 is the fluid management component of the present invention as shown in FIG. 2 with channels etched in one face of the component for directing the flow of carbon dioxide;

FIGS. 4A-4D illustrate top plan views of the fluid management component of the present invention including various configurations of flow channels for carbon dioxide;

FIG. 5 is a schematic view of the invention in contact with an MEA of traditional design;

FIG. 6A is a schematic illustration of the fuel cell system including the fluid management of the present invention which is employed in addition to the conventional anode diffusion layer and a current collector element is added as an alternative to collecting the current through the element;

FIG. 6B is another embodiment of the fuel cell system of the present invention in which the component is used in conjunction with a separate current collector;

FIG. 6C is a schematic block diagram of a fuel cell in which the fuel management component of the present invention is employed instead of the traditional anode diffusion layer;

FIG. 7 is an isometric illustration of one embodiment of the invention that includes a microperforated layer;

FIG. 8A is a schematic cross section of a simplified fuel cell system enabled by the invention, and including an invention component in the anode area of the fuel cell; and

FIG. 8B is a schematic cross section of an alternate simplified fuel cell system enabled by the invention, and including an invention component in the anode area of the fuel cell.

### DETAILED DESCRIPTION OF AN ILLUSTRATIVE EMBODIMENT

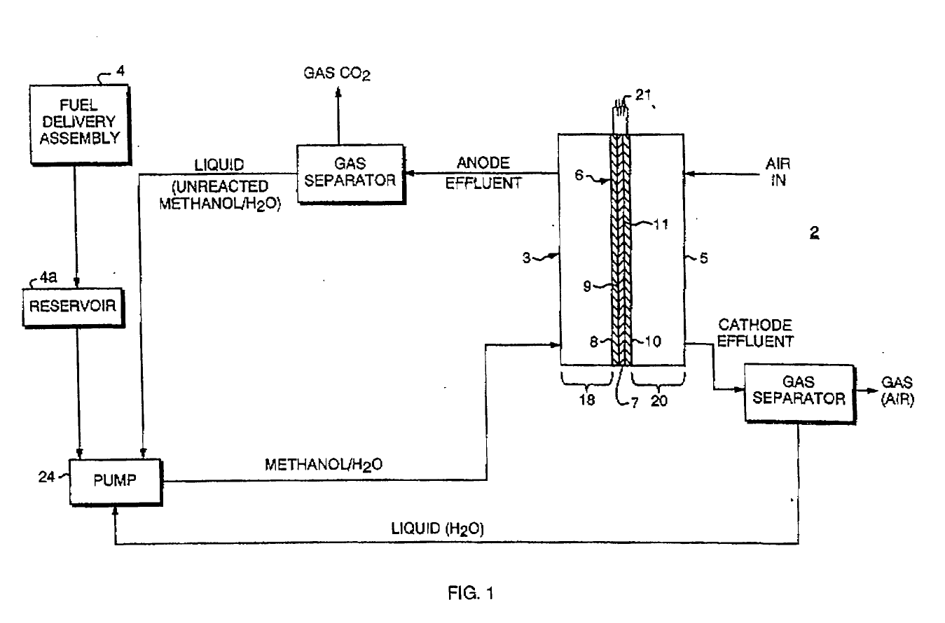

For a better understanding of the invention, the components of a direct oxidation fuel cell system, a direct oxidation fuel cell and the basic operations thereof, as set forth in the prior art will be briefly described. A direct oxidation fuel system 2 is illustrated in FIG. 1. The fuel cell system 2 includes a direct oxidation fuel cell, which may be a direct methanol fuel cell 3 (“DMFC”), for example. For purposes of illustration we herein describe an illustrative embodiment of the invention with DMFC 3, with the fuel substance being methanol or an aqueous methanol solution. It should be understood, however, that it is within the scope of the present invention that other fuels may be used in an appropriate fuel cell. Thus, as used herein, the word “fuel” shall include methanol, ethanol, or combinations thereof and aqueous solutions thereof, and other carbonaceous fuels amenable to use in direct oxidation fuel cell systems. The invention can be used in any fuel cell system wherein it is desirable to manage the rate of supply and local concentration of the fuel, and therefore can be used in any number of designs based on fuel cells that employ a proton conducting membrane electrolyte.

The system 2, including the DMFC 3, has a fuel delivery system to deliver fuel from fuel source 4 (reservoir 4a may be utilized, but is not necessary for operation of the DMFC system). The DMFC 3 includes a housing 5 that encloses a cell employing a membrane electrode assembly 6 (MEA). MEA 6 incorporates protonically conductive, electronically non-conductive membrane (PCM) 7. PCM 7 has an anode face 8 and cathode face 10, each of which may be coated with a catalyst, including but not limited to platinum and/or a blend of platinum and ruthenium particles or alloy particles. The portion of DMFC 3 defined by the housing 5 and the anode face of the PCM is referred to herein as the anode chamber 18, or the anode compartment 18. The portion of DMFC 3 defined by the housing and the cathode face of the PCM on the cathode side is referred to herein as the cathode chamber 20, or the cathode compartment 20. As used herein, the term electrode compartment and/or electrode area is a reference to either the anode chamber or area or the cathode chamber or area as dictated by context. Additional elements of the direct methanol fuel cell system such as flow field plates, and diffusion layers (not shown in FIG. 1) to manage the transport of reactants and byproducts may be included within anode chamber 18 and cathode chamber 20.

As will be understood by those skilled in the art, electricity-generating reactions occur when a fuel substance is introduced to the anode face of the PCM 8, and oxygen, usually in the form of ambient air, is introduced to the cathode face of the PCM 10. More specifically, a carbonaceous fuel substance from fuel source 4 (possibly via reservoir 4a) is delivered by optional pump 24 to the anode chamber 18 of the DMFC 3. The fuel mixture passes through channels in a flow field plate, and/or a diffusion layer, and is ultimately presented to the PCM. Catalysts on the membrane surface (or which are otherwise present in the anode chamber) enable the direct oxidation of the carbonaceous fuel on the anode face of the PCM 8, separating hydrogen atoms and carbonaceous intermediates from the fuel molecules in the fuel mixture. Upon the closing of a circuit, hydrogen atoms separate into protons and electrons and the protons pass through PCM 7. The carbonaceous intermediates are, at the same time, oxidized into carbon dioxide, using oxygen molecules from the water in the fuel mixture, yielding more protons and electrons. The electrons travel through a load 21 of an external circuit, providing electrical power to the load. So long as the reactions continue, a current is maintained through the external circuit. Direct oxidation fuel cells typically produce water (H₂O), carbon dioxide (CO₂), and heat as products of the reaction.

First Embodiment

The first embodiment of the invention is applicable where fuel is delivered to the catalyzed membrane electrolyte without actively-applied hydraulic pressure (i.e. where there is an insignificant pressure drop across the fuel management component) or by using a fuel delivery system where, by way of illustration and not for the purpose of limitation, a wicking or capillary action is used to deliver the fuel to the component).

As noted herein, liquid feed fuel cells and, in particular, direct methanol fuel cells, as typically fabricated using presently available techniques are subject to several shortcomings related to fluid management. These shortcomings can limit the effectiveness of DMFCs as a power source. More specifically, because the membrane electrolyte of a DMFC is typically quite permeable to methanol, a significant amount of concentrated fuel mixture that is introduced into the anode chamber can pass through the membrane and be oxidized on the cathode face of the membrane. This wastes fuel, and diminishes cathode performance. As a result, DMFC systems with polymer electrolyte membranes are typically required to either carry a very dilute methanol solution in the fuel tank, which reduces the energy density of the fuel cell system by increasing the overall volume of the system, or, alternatively, a fluid flow control system is used to manage the concentration of the fuel/water mixture within the anode chamber at the low level required to sufficiently limit the rate of methanol crossover through the membrane. Fuel flow control systems add volume, complexity and cost to the system.

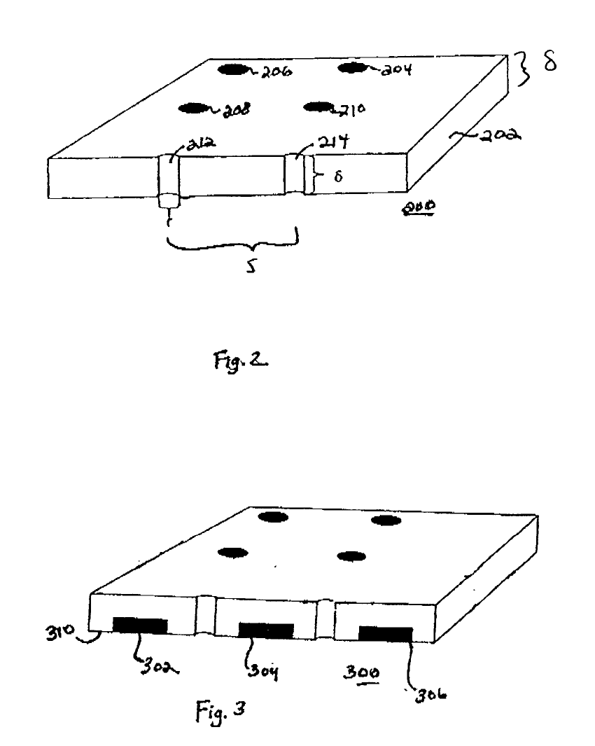

In accordance with the present invention, a fluid management component 200, as illustrated in FIG. 2 is used in a fuel cell system 3 (FIG. 1) to manage the flow of fluids to and from the anode surface of the membrane electrolyte. A component 200, described in FIG. 2, can be accurately designed to achieve effective anode fluid management where the effects of hydraulic pressure drop across the element are not significant and the introduction of fuel through the element will be determined by diffusional flux. The component 200 is comprised of a plate 202 that has openings 204-210. Several openings 212, 214 are shown in a cutaway portion of FIG. 2. Generally, the relationship between the fluid presentation area and the “footprint” of the component can be expressed as (Number of pores×Average pore area)/Area of component. In this instance, the opening 212 is shown as a cylindrical pore, having a radius r, though other geometries are possible. The distance between the centers of the pores 212 and 214 is illustrated as the distance s. For circular pores that are uniformly distributed on the plate 200, f=(πr² )/(s²) where f is the aggregate fraction of the component surface area and volume that is open due to the pores in the component and where the spacing s is uniform.

This aggregate fraction f and affects the flux of fuel that is allowed to pass and be disbursed by the component 200. As used herein, flux is defined as the net flow of methanol (or other concentrated fuel) moles per unit area of the perforated plate 200 per unit time, and is a function of f. It is expressed as moles transported per square centimeter per second.

When the component 200 is selectively perforated to allow the fuel to pass through it at a given diffusional flux, (diff.fl),the approximate relationship, for the diffusional flux is as follows:

cJ_{cell}=(nF)[diff.fl.]=(nF)[(DC/δ)]f 1.

where each parameter is as follows:

c: a multiplier: This multiplier is introduced to provide fuel flux somewhat above cell current demand. In accordance with the invention, it has been determined that this is typically between about 1.1 and 1.5, and preferably is approximately 1.2, to achieve a strong drop in methanol concentration across the thickness of the component plate while minimizing the probability of fuel starvation.

J_{cell}: fuel cell current density along the active area of the MEA in amperes per cm²;

F: Faraday constant of 96,485 coulombs/mole of electrons;

n: number of electrons generated per mole of fuel (n=6 for methanol);

D(in cm² per second): Diffusion coefficient of methanol in aqueous methanol solution. If there are any significant capillary forces that affect the flux through the plate holes then D may be adjusted to account for such;

δ: Thickness of component, in centimeters;

f: Aggregate fraction of component cross-sectional area that is open due to pores in the system; and

C: Concentration of Methanol that is introduced to the component, in moles per cm³.

In accordance with the present invention, under the given assumptions, it is possible to accurately control the concentration of methanol at the catalyzed anode surface of the membrane electrolyte for a given high concentration C of methanol in the anode compartment 18 and a demand current J, when the component 200 is placed within the anode compartment adjacent to the anode face of the electrode assembly. In accordance with one aspect of the invention, methanol concentration may be between about 15 and 24 Molar methanol, with a component thickness δ of about 1 millimeter, or less. Alternatively, in other instances, neat methanol can be used with a component thickness δ of about 1 millimeter or less, if desired.

It is within the scope of the present invention that the pores, such as the pore 206 in FIG. 2, may be any desired shape depending upon a particular application or ease of manufacture in a particular instance. For example, a pore may be round or square. A pore can be of equal dimensions straight through the plate or can be tapered, as in a funnel shape. In addition, the pores need not be perfectly straight, but may be tortuous or branched. The pores can be sized and spaced in a manner suitable in a particular application to achieve an aggregate fraction of the component that is open to flow due to the pore openings. And, as noted herein, the parameter f which is the aggregate fraction of the component that is open, is determined by the current density demand and the methanol concentration in the anode chamber in accordance with equation 1. It is preferred that the constant multiplier c is held typically between 1.1 and 1.5 in order to provide a flux somewhere above cell current demand. Thus, the radius of the pores (FIG. 2) and the distance between pores, s can be adjusted to adjust the component f in accordance with the equation, as desired in a particular application.

In addition to size and shape of pores, it may be necessary or desirable that the internal walls of the pores be hydrophilic in nature to ensure regular transport of aqueous methanol liquid to the anode diffusion layer, or directly to the catalyzed anode surface of the membrane electrolyte.

Whereas the well-defined geometry of well defined pores in the component depicted in FIG. 2 provides a precise, calculated route for achieving a required concentration drop across the component at a given current demand J_{cell}, the optimized permeability in the component can also be achieved using other porous layer structures which provide appropriate levels of porosity within a component. Porosity/tortuosity combinations in components formed, for example using sintered metal powders, metal sponges, porous carbon or graphite or composites thereof, polymers with a “spongy” structure, or other woven or non-woven structures, all of which can be fabricated using techniques known to those skilled in the art, could all result in parameter f that is substantially identical to that achieved by establishing a well-defined array of cylindrical pores. If such a comparatively disordered porous network is to be used, then f will have to be experimentally determined, as opposed to being predictable using a geometric equation. Such experimental determination can be made by fabricating an electrochemical cell as set forth in Methanol Cross-over in Direct Methanol Fuel Cells, Proton Conducting Membrane Fuel Cells, Electrochemical Society Proceedings Volume 95-23, pp 284-293, by placing the component adjacent the cell anode, and applying a voltage sweep from 0 to +1 volt between the electrodes of said electrochemical cell. The limiting current obtained in this measurement defines, according to Equation 1, the effective value of f for the any type of pore network in a component of overall thickness δ.

The component 200 of the present invention can be fabricated from any material that does not degrade in the presence of the fuel mixture, including but not limited to titanium nitride coated metals, polymers such as polyethylene or polypropylene, stainless steel alloys, titanium, silicon, silicon carbide or other selected materials such as ceramic materials, carbon and graphite composites, plastic composites, silicon dioxide, treated fiberglass, or other suitable materials or composites. If the component 200 is fabricated from a conductive material such as stainless steel, then the component 200 can also be used as a current collector in the fuel cell as described hereinafter. If the component 200 is fabricated from an insulating material, then current collection can be accomplished via a carbon-based diffusion layer placed between the component and the membrane electrolyte, or other dedicated current collecting component, including but not limited to a mesh which is incorporated between the diffusion layer and the component. Alternatively, metal deposition methods such as sputtering, chemical vapor evaporation, or physical evaporation can be used to establish a current collector on the component 200, in accordance with methods that will be understood by those skilled in the art.

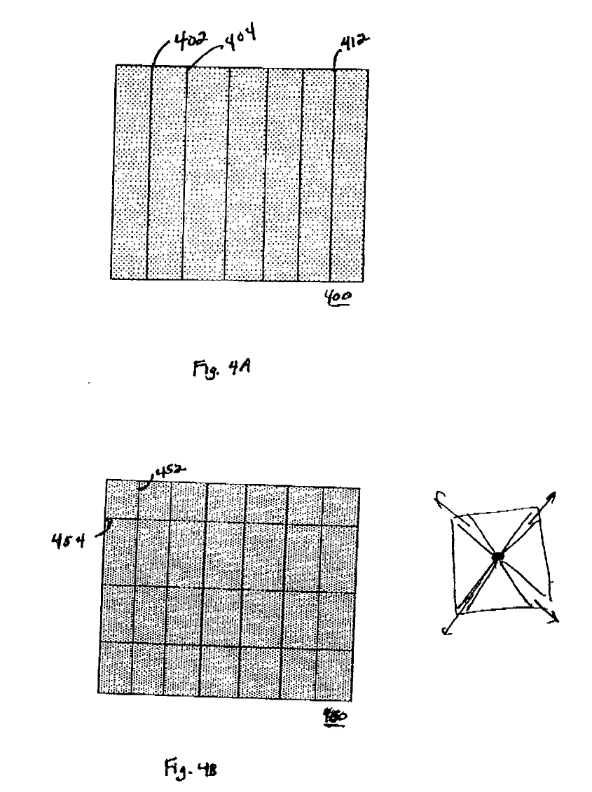

As noted herein, a product of the electricity generating reactions is carbon dioxide. In accordance with the present invention, the component can be used to aid in the collection of product gases such as carbon dioxide. With reference to FIG. 3, a component 300 is fabricated in accordance with the present invention to include channels 302, 304 and 306 for example. The channels 302-306 are formed in the component 300 in such a manner that they direct the carbon dioxide produced in the anodic reactions in a predetermined direction to vent or use to perform work within the fuel cell system. These channels may be embossed, etched or otherwise formed on the aspect 310 of the component 300 that faces the membrane electrolyte or diffusion layer. The channels 302-306 allow anodically generated carbon dioxide to be collected and directed towards a predetermined collection point or vented to the ambient environment. The channels 302-306 may be formed by any suitable process, known to one of ordinary skill in the art, such as micromolding, embossing, or in the silicon embodiment of the component etching or micromachining. The channels 302-306 can further be treated with a hydrophobic material in order to prevent water from entering and filling the channel and impeding the removal or direction of the carbon dioxide.

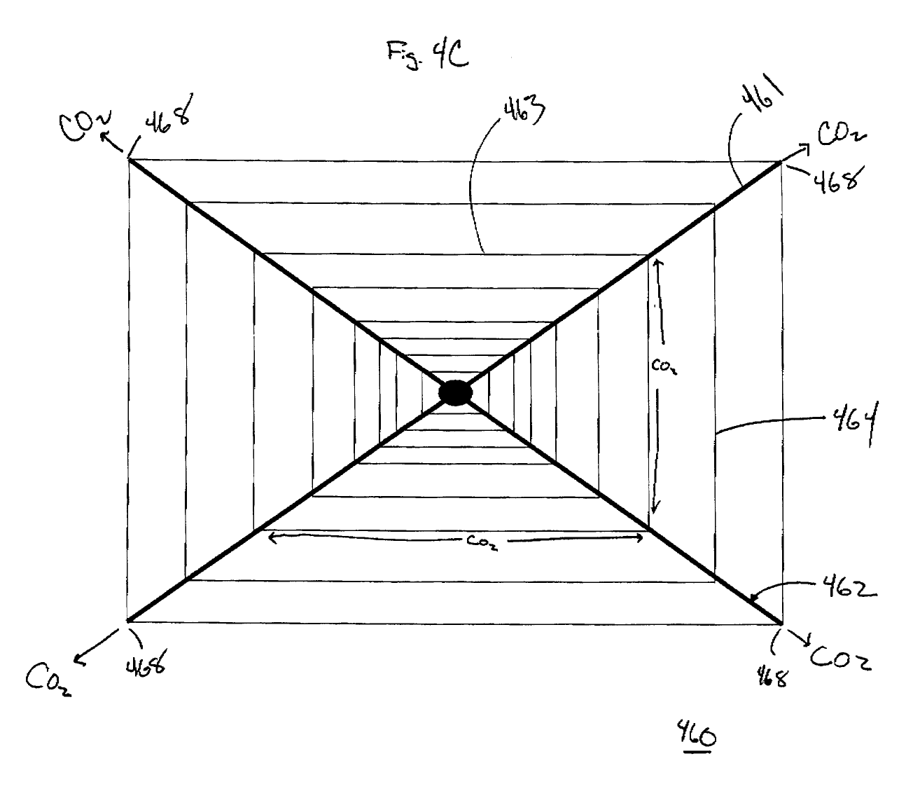

More specifically, as illustrated in FIG. 4A, the component 400 has parallel channels 402-412, which extend along a single aspect of the component 400 to vent the carbon dioxide. In an alternative embodiment of the invention, as illustrated in FIG. 4B, the component 450 includes cross-hatched channels 452 and 454, for example, which allow the escape of carbon dioxide in each lateral direction away from the membrane electrolyte. There are many alternate routing schemes with channels which allow more effective collection of anodically generated gasses depending upon the particular application in which the fuel cell is used. For example, in FIG. 4C, there are diagonal, removal channels 461, 462 and also smaller collector channels 463, 464 formed in component 460. The smaller collector channels 463, 464, and the larger removal channels are in communication with one another. Anodically generated carbon dioxide is captured by the collector channels, and ported to any number of carbon dioxide outlets 468, located proximate to the end of the removal channels. This routing allows for improved collection of carbon dioxide by the component 460. The effectiveness may be further enhanced by slightly contouring either the collector channels and/or the removal channels within the component to encourage the flow of carbon dioxide towards the desired point of exit.

A similar embodiment shown in FIG. 4D allows carbon dioxide to be collected in collecting channels 474, 475 routed to removal channels 472, 473 and vented through port 476. Each of these descriptions are for the purposes of illustration, and not by way of limitation, given that there are virtually infinite ways in which said channels can be formed on the component to collect the anodic products of the reaction.

The hydrophobic nature of the carbon dioxide channels (FIGS. 3 through 4A-4D), and the hydrophilic nature of the pores (FIG. 2), create a preference for the carbon dioxide to be directed to and along the carbon dioxide channels. An additional benefit of releasing the carbon dioxide as close as possible to the catalyzed membrane electrolyte is that the concentration of methanol is lowest here and thus vaporous methanol loss by the carbon dioxide effluent stream is minimized.

In order to ensure that the effluent gasses are efficiently removed from the fuel cell and fuel cell system, it is necessary to prevent said gasses from escaping instead into the liquid fuel in the anode chamber. As such, it may be further desirable to fill the pores of the component with a material that is permeable to the methanol and water fuel mixture and substantially impermeable to carbon dioxide or other effluent gasses.

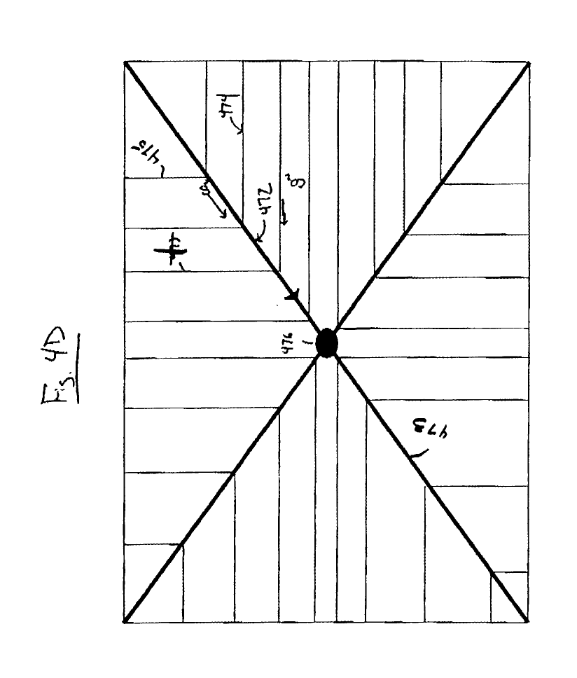

The component can be placed in proximity to, or in contact with an MEA as set forth in FIG. 5. The component 502 is placed generally between the membrane electrolyte 505 and the anode chamber 504 of the fuel cell, and specifically, is in contact with the anode diffusion layer 510 within a fuel cell. The component may be mechanically integrated with, or in intimate contact with MEA 501 generally, or anode diffusion layer 510 specifically. The component 500 may also include at least one, and preferably a multitude of channels along the aspect of the component that is in contact with, or which faces the membrane electrolyte, to provide a vent for anodically generated gasses, including, but not limited to carbon dioxide. The component 502 also includes the carbon dioxide exhaust areas 520 and 530. The areas 520 and 530 lead to a vent out of the fuel cell or to a collection chamber, which may utilize a gas/liquid separator to prevent liquid from exiting the fuel cell. In this way, the component 502 of the present invention effectively removes anodically generated gases. The electrical load may be connected using methods and components well known to those skilled in the art, typically using the diffusion layers to collect and conduct current from the catalyst to a current collector. The component may be used as a current collector, and the load connected directly to the component as a means by which current can be delivered to the device being powered.

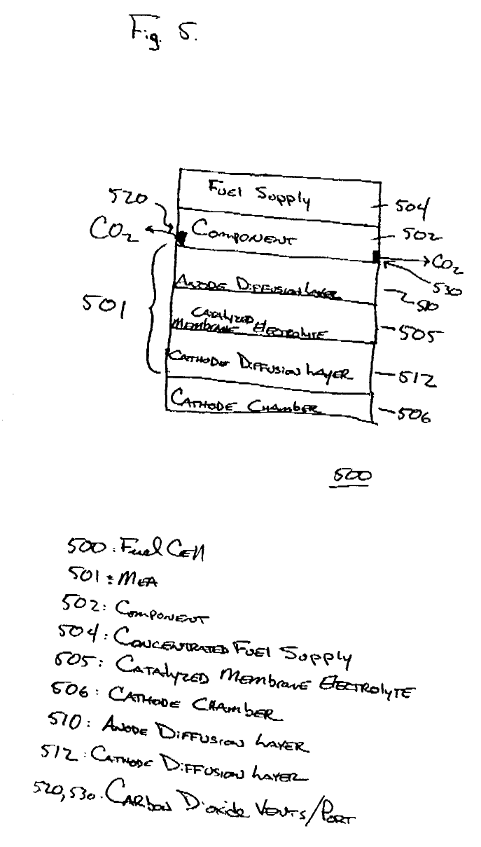

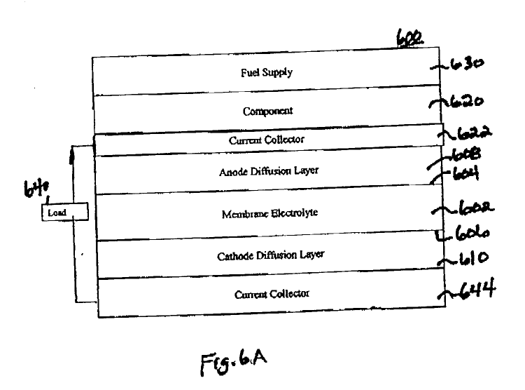

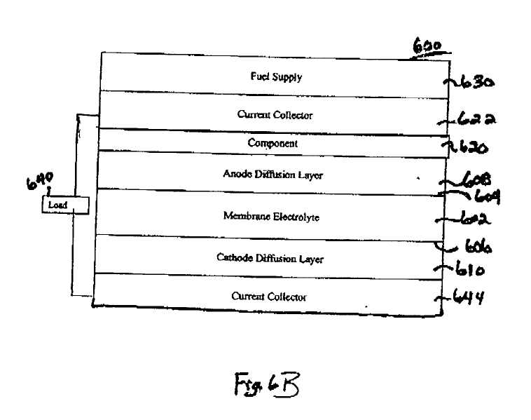

A schematic of a fuel cell that employs the component of the present invention is illustrated in FIG. 6A. In this embodiment, the membrane electrolyte 602 has an anode diffusion layer 608 adjacent to its anode face 604 and a cathode diffusion layer 610 adjacent to the cathode face 606. The fuel management component of the present invention 620 is placed adjacent to the anode diffusion layer with an optional current collector 622, such as a metal mesh, placed between the membrane electrolyte and the component. In this case, the component is located on the aspect of the diffusion layer opposite the membrane electrolyte. The component in this embodiment may be constructed of either conductive or non-conductive materials including, but not limited to plastics, metals or ceramics. If the component 620 is fabricated using a non-conductive material, the electricity generated in the electricity generating reactions is conducted using current collector 622 that is placed between the anode diffusion layer 608 and the component 620. Alternatively, current may be collected via the anode diffusion layer 608, by utilizing a current collector that is within the anode diffusion layer (not shown).

If the component is fabricated from a conductive material, then anode current collector 622 can be eliminated from the assembly, and component 620 can be used to connect the load from the anode aspect of the fuel cell. It is, of course, possible to implement current collector 622 even if component 620 is fabricated from a conductive material.

In accordance with another aspect of the invention, as illustrated in FIG. 6B, the fuel cell 600 includes a component 620, which is similar to that illustrated in FIG. 6A. In FIG. 6A, the component 620 of the present invention is layered adjacent to a current collector which in turn is in contact with an anode diffusion layer, and opposite the membrane electrolyte. In the embodiment of FIG. 6B, on the other hand, the component 620, is in contact with the anode diffusion layer 608. In this embodiment the component 620 must be fabricated from a conductive material, so that the electrons may flow to the current collector 622, or directly to the load 640. In some instances, it is preferable to use a current collector, such as when the component is fabricated from a material, whose lateral conductivity is insufficient, although its through-plane conductivity is satisfactory. In other applications, it may be desirable to avoid the use of a separate current collector layer, and it should be understood that the present invention is readily adaptable to accommodate both of these scenarios.

Another configuration of a fuel cell system that employs the component of the present invention is illustrated in FIG. 6C in which like elements have the same reference characters as in FIGS. 6A and 6B. In this embodiment, the anode diffusion layer is rendered unnecessary. As illustrated in FIG. 6C, the fuel cell 600 includes a membrane electrolyte 602. The membrane electrolyte has an anode face 604 and a cathode face 606. Adjacent to the cathode face is the cathode diffusion layer 610. Adjacent to the anode face is the component of the present invention 620 and a current collector 622. In addition to controlling the rate of fuel flow to the anode catalyst, the fluid management component of the present invention in this embodiment is acting to replace the functionality of the anode diffusion layer. As such, the component of present invention 620 in accordance with this aspect of the invention, is preferably a highly conductive material. In the embodiment of FIG. 6C, the component 620 of the present invention acts to disburse the fuel from the fuel supply 630 to the anode face 604 of the membrane electrolyte. It also allows carbon dioxide to escape the system as described hereinbefore with reference to FIGS. 4A and 4B, for example and it also acts as the current collector to which the load 640 is connected. It is noted that the pores and the carbon dioxide channels, described earlier, are not visible in FIGS. 6A-C because these are schematic cross-section diagrams of the fuel cell 600.

In order to ensure that the effluent gasses are removed from the fuel cell and fuel cell system, it may be necessary to prevent said gasses from escaping instead into the liquid fuel stream present in the anode chamber. As such, it may be desirable to fill the pores of the component with a material, which is permeable to the methanol and water fuel mixture and substantially impermeable to carbon dioxide or other effluent gasses.

Where hydraulic pressure is non zero, its effects must be determined and taken into account. This may be accomplished by establishing a component 200 with a finer porosity than would be implemented when flux is to be determined almost entirely by diffusion. The ideal porosity for a component may be determined through experimentation, depending on the fuel cell and fuel cell system in which the element is implemented. Determination of hydraulic permeability through a porous plate is well known to those skilled in the art. When the flux through the component is determined by the hydraulic permeability of the component, Kₕ, the following equation ties cell current to the pressure drop across the element and the concentration of the fuel supply upstream from the element: CJ_{cell}=Kₕ·P·C, where Kₕ is hydraulic permeability given, for example, in cubic centimeters of liquid flowing through the component per square centimeter of the component per second per given pressure differential across the component. P is the pressure differential across the component (PSI) and the rest of the parameters on the equation are as defined in equation 1. In the different configurations and with any pore geometry of the flow management component discussed herein, the component's porosity is preferably between 5 and 100 times finer than that of the anode diffusion layer, and more preferably between 10 and 50 times finer than that of the anode diffusion layer. The exact level of porosity that is desirable in a given system depends on the design of, and the demands on a system, including but not limited to consideration of the overall thickness of the component that preferably will be kept under 1 millimeter.

Second Embodiment

If additional applied hydraulic pressure is present “upstream” of the component, i.e. if the concentrated fuel is being driven towards the membrane electrolyte by pressure or by a pump, then excessive concentrated or pure fuel may be undesirably introduced to the catalyzed membrane through the pores of the component. The hydraulic pressure, however, may be desirable to ensure that fuel is consistently delivered to the catalyzed membrane electrolyte. Therefore, under conditions of significant hydraulic pressure, i.e. greater than 0.01 PSI, it is preferable to modify the invention to account for said hydraulic pressure, by further limiting the overall effective porosity of the component to control the amount of methanol that reaches the membrane.

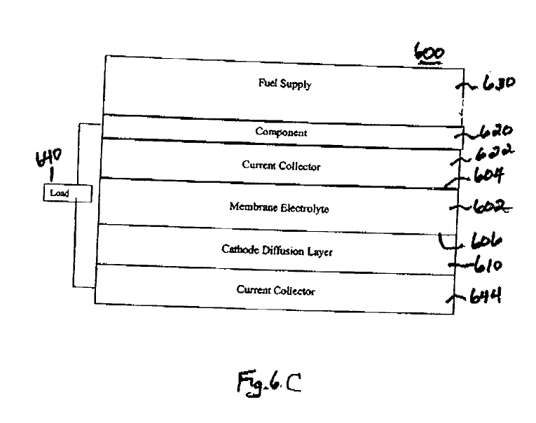

A preferred method of further limiting the flux at the face of the component is set forth in FIG. 7. Component 700 is substantially similar to component 200 of FIG. 2, except that microporous layer 701 is attached or applied to body of the component 702, on the aspect of the component 700 that is adjacent the fuel supply and opposite the membrane electrolyte or anode diffusion layer. Microporous layer 701 may consist of engineered polyethylene or other engineered membrane, or may be cast using appropriate materials. Specifically, microporous layer 701 may consist of a microperforated membrane, where said microperforations may be as small as 0.01 micrometer in diameter, as opposed to pores in the component 200, whose size is typically greater than 0.1 micrometers. Due to the greatly reduced pore size of the microporous layer, flux under hydraulic pressure is well controlled.

The microporous layer is typically bonded to, or mechanically integrated to the component, and it has fluidic characteristics that are selected to work in conjunction with the body of the component 702 in order to optimize the performance of the fuel cell and the fuel cell system.

This embodiment of the invention can be employed as set forth in any cell architecture where the component is in substantial contact with the fuel supply, for example in FIG. 6A, and FIG. 6C.

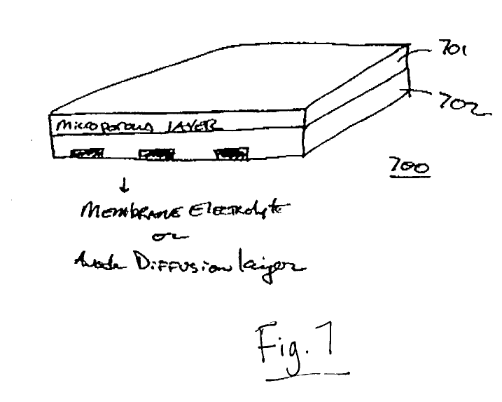

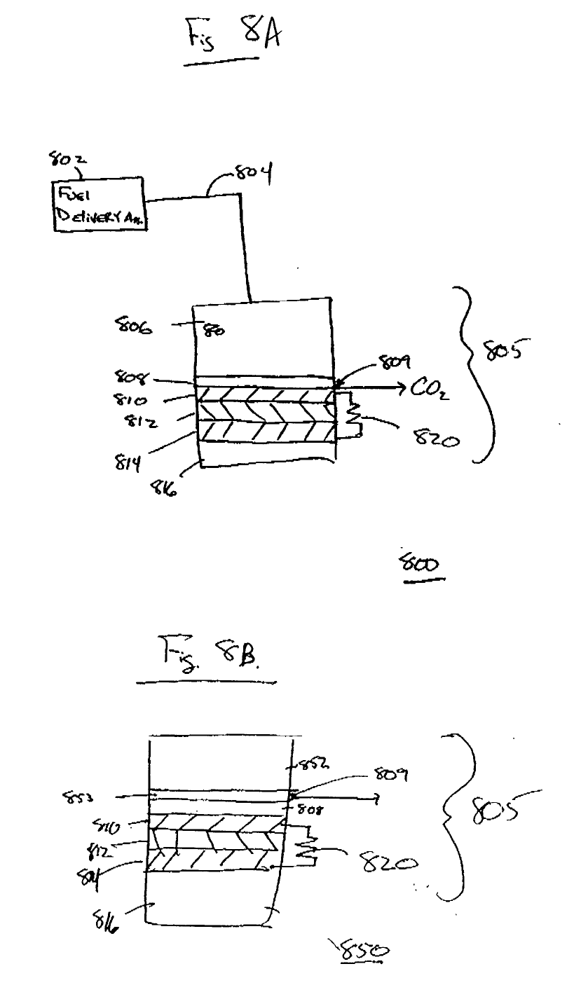

Either embodiment of the component provides a means by which a high fuel concentration can be managed without the need for dilution or mixing by pumping. By implementing the component, a much simpler fuel cell system, such as that shown in FIG. 8A can be implemented. System 800, is comprised of a fuel source 802, preferably comprised of a cartridge that contains a concentrated fuel, a fuel conduit 804, a fuel cell 805, and an electrical circuit connected between the anode and cathode as set forth within this application. It may be desirable to utilize a pump or internal reservoir (not shown) between fuel source 802 and fuel cell 805 and in communication with conduit 804. Concentrated fuel from fuel source 802, is then delivered to the anode chamber 806, and is introduced to component 808. Fuel is then supplied directly to the anode diffusion layer 810, and the catalyzed membrane electrolyte 812, at a controlled flow rate defined by the component 808 porosity while oxygen is introduced to the cathode diffusion layer 814 and the cathode aspect of the catalyzed membrane electrolyte 812 via the cathode chamber 816. Upon completion of the circuit 820 the electricity generating reactions common to direct methanol fuel cell systems occur, and current passes through the circuit 820. In this simple system, the need to use mechanical means to achieve controlled dosing and mixing of the concentrated fuel (as illustrated in FIG. 1) is eliminated.

Anodically generated carbon dioxide is removed from the system by the component 808, and exits the fuel cell through carbon dioxide port 809. Though shown as exiting the fuel cell system, carbon dioxide may be utilized to perform mechanical work within the system. As such, the system is greatly simplified by providing a simple effective means by which fuel flow directly from a concentrated fuel supply can be managed.

A further step in simplification is shown in FIG. 8B. For purposes of clarity, similarly numbered parts are substantially identical to those in FIG. 8A. In this system 850, concentrated fuel is stored in the anode chamber 852, which may be enlarged to accommodate a sufficient volume of highly concentrated fuel and acts as a fuel container, making the fuel delivery assembly and fuel conduit shown in FIG. 8A as 802 and 804, respectively, unnecessary. An optional “shutter” 853 which can be used to physically block fuel from being introduced to component 808 may be introduced to separate the fuel from the anode when required. Once fuel is introduced to the anode diffusion layer, the fuel cell operates as described with reference to FIG. 8A. The ability to use such a simple system to utilize a direct methanol fuel cell with a membrane electrolyte 850, depends on the ability to control the flow of fuel to the anode catalyst by means of the component discussed herein, according to equations 1 and 2 as set forth herein using a concentrated methanol solution, or even neat methanol, in the anode chamber/reservoir.

The foregoing description has been directed to specific embodiments of the invention. It will be apparent however that other variations and other modifications may be made to the described embodiments, with the attainment of some or all of the advantages of such. Therefore, it is the object of the appended claims to cover all such variations and modifications as come within the true spirit and scope of the invention.

What is claimed is:

1. A fluid management component for use in a direct oxidation fuel cell having a membrane electrode assembly and having an anode compartment and a cathode compartment, and an associated source of fuel that delivers a fuel substance to the anode face of the membrane electrode assembly, the component comprising:
a plate comprised of a material that is non-reactive to the fuel substance, said plate having a plurality of pores therein of a diameter and spacing such as to allow a predetermined flow of fuel substance to pass through the plate towards an anodic face of the membrane electrode assembly to be used in generating electricity.

2. The fluid management component as defined in claim 1 with parallel, cylindrical pores wherein said pore spacing defined by the distance between pore edges, s, and the radius of each pore, r, are related to the aggregate open area of said plate, f by the equation f=(πr² )/(s²), which is in turn related to the concentration in the anode compartment and the current density across said plate, and f is maintained at such an amount that a strong drop in fuel concentration occurs across the plate while minimizing the probability of fuel starvation.

3. The fluid management component as defined in claim 2 wherein said component is perforated with pores to allow the fuel to pass through said plate at a given flux that is predetermined in accordance with the relationship of cJ_{cell}=(nF)[(DC/δ)]f.

4. The fluid management component as defined in claim 3 wherein said constant multiplier, c, is maintained at a value of between about 1.1 and 1.5.

5. The fluid management component as defined in claim 4 wherein said constant multiplier is valued at 1.2.

6. The fluid management component as defined in claim 3 wherein the effective porosity defined by f is achieved by sintering metal particles or by the intrinsic or engineered porosity in a polymeric membrane.

7. The fluid management component as defined in claim 3 wherein C is between 15 and 24 molar methanol can be used, with component thickness, δ, of 1 millimeter or less.

8. The fluid management component as defined in claim 3 wherein neat methanol can be used, with component thickness, δ, of 1 millimeter or less.

9. The fluid management component defined in claim 1, wherein the flow of fuel is determined by the hydraulic permeability of the component Kₕ, which is determined, in turn by the component porosity, and a high concentration C in the anode chamber can be used for current demand J_{cell}=,Kₕ·P·C, and P is the hydraulic pressure drop across the component.

10. The fluid management component as defined in claim 1 wherein said plate is substantially comprised of a highly conductive material.

11. The fluid management component as defined in claim 1 wherein said plate is substantially comprised of an insulative material.

12. The fluid management component as defined in claim 1 wherein said plate is substantially comprised of a polymeric material.

13. The fluid management component as defined in claim 1 wherein said plate is substantially comprised of stainless steel.

14. The fluid management component as defined in claim 1 wherein said plate is comprised substantially of silicon.

15. The fluid management component as defined in claim 1 wherein said plate is comprised substantially carbon or graphite.

16. The fluid management component as defined in claim 1 wherein said plate is comprised substantially of silicon dioxide.

17. The fluid management component as defined in claim 1 wherein said plate is comprised substantially of treated fiberglass.

18. The fluid management component as defined in claim 1 wherein said plate also having channels formed on an aspect thereof that is not adjacent to the anode compartment, said channels positioned in such a manner so as to direct the flow of gases in said fuel cell to a predetermined site.

19. The fluid management component as defined in claim 14 wherein said channels are parallel tracks formed along one aspect of said plate.

20. The fluid management component as defined in claim 14 wherein said channels are formed in a cross-hatched pattern.

21. The fluid management component as defined in claim 14 further comprising carbon dioxide exhaust vents to release carbon dioxide produced in an anodic reaction from the fuel cell.

22. A direct oxidation fuel cell, comprising:
(A) a membrane electrode assembly, including:
(i) a protonically conductive, electronically non-conductive membrane electrolyte having an anode face and an opposing cathode face; and
(ii) a catalyst coating disposed upon each of said anode face and said cathode face, whereby electricity-generating reactions occur upon introduction of an associated fuel substance including anodic conversion of said fuel substance into carbon dioxide or other carbonaceous product, protons and electrons, and a cathodic combination of protons, electrons and oxygen from an associated source of oxygen, producing water;
(B) a fluid management component disposed on an anode side of said membrane electrode assembly, and said fluid management component having a plurality of openings therein to allow said fuel substance to pass through at a controlled rate set by component's porosity or tortuosity, to said anode face of said membrane electrode assembly to produce said electricity generating reactions; and
(C) a load coupled across said fuel cell providing a path for said free electrons produced in said electricity-generating reactions.
